(19) United States
(12) Patent Application Publication
(10) Pub. No.: US 2008/0098775 A1
(43) Pub. Date: May 1, 2008

(54) DOOR LOCK ASSEMBLY THAT CAUSES A HANDLE TO IDLE WHEN PLACED IN A LOCKING POSITION

(76) Inventors: Lan-Kun DON, Chiayi City (TW); Po-Yang CHEN, Chiayi City (TW); Ching-Chuan KUO, Chiayi County (TW)

Correspondence Address: LADAS & PARRY LLP, 224 SOUTH MICHIGAN AVENUE, SUITE 1600, CHICAGO, IL, 60604, US

(21) Appl. No.: 11/928,031

(22) Filed: Oct. 30, 2007

(30) Foreign Application Priority Data
Oct. 31, 2006 (TW) 095219263

(51) Int. Cl. E05B 65/06

(52) U.S. Cl. 70/101

(57) ABSTRACT

A door lock assembly includes a spindle tube inserted rotatably into a sleeve connected to a handle. A spindle drive is disposed in the spindle tube adjacent to a driven shaft that is disposed in the spindle tube and that has a driven part driven by a driving tooth of the spindle drive to rotate the driven shaft. A clutch tube is inserted into the spindle tube and is sleeved around the driven shaft. The clutch tube is connected movably to and moved by the driven shaft so that the clutch tube is connected to the sleeve in an unlocking position of the door lock assembly, or separated from the sleeve in a locking position. Thus, the handle idles in the locking position.

### CROSS-REFERENCE TO RELATED APPLICATION

This application claims priority of Taiwanese Utility Model Application No. 095219263 filed on Oct. 31, 2006.

### BACKGROUND OF THE INVENTION

1. Field of the Invention

This invention relates to a door lock assembly, more particularly, to a door lock assembly having inner and outer handles which idle when a door is locked by the door lock assembly.

2. Description of the Related Art

There are door lock assemblies which are provided with inner and outer handles that can be rotated to operate a latch mechanism for latching or unlatching a door. The inner and outer handles are connected respectively to inner and outer sleeves. A rotary spindle inserted into the outer sleeve is connected to a latch actuator or retractor which in turn is connected to the latch mechanism. A press button rod is disposed within the inner sleeve and is connected to the rotary spindle. When a key plug disposed within the outer handle and connected to the rotary spindle is operated through a right key, the latch mechanism can be placed in a locking or unlocking state. When a press button disposed within the inner handle and connected to the press button rod is pressed, the latch mechanism is placed in a locking state. Therefore, such door lock assemblies have a key plug only in the outer handle, and are operated through a key at the outside of a door and through a press button at the inside of the door Examples thereof are disclosed in U.S. Pat. Nos. 6,038,894, 6,615,630, 5,868,018, and 6,575,006. These patents also teach that such a door lock assembly may have a handle that can idle when a door is locked by operating the key plug or the press button.

### SUMMARY OF THE INVENTION

An object of the present invention is to provide a novel door lock assembly that permits a door to be unlatched by rotating a handle when the door lock assembly is an unlocking position, and that causes the handle to idle when the door lock assembly is in a locking position.

According to this invention, a door lock assembly comprises: a handle including a key plug that has a tailpiece; a sleeve connected to the handle and having a first engaging element connected to the sleeve; a latch unit adapted to latch a door; a spindle tube inserted rotatably into the sleeve and having a spindle tab to operate the latch unit; a spindle drive disposed rotatably in the spindle tube, and having a driving tooth, and a central slot into which the tail piece is inserted; a driven shaft disposed rotatably in the spindle tube, and having a driven part driven by the driving tooth to rotate the driven shaft; and a clutch tube inserted movably into the spindle tube and sleeved movably around the driven shaft. The clutch tube has a second engaging element to engage releasably the first engaging element. The clutch tube is connected movably to and moved by the driven shaft so that the second engaging element moves to and engages the first engaging element when the door lock assembly is in an unlocking position, or moves away from the first engaging element when the door lock assembly in a locking position.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is an exploded view of a door lock assembly embodying the present invention;

FIG. 2 is an exploded view showing components of inner and outer transmission units of the door lock assembly;

FIG. 3 is an enlarged exploded view showing some of the components depicted in FIG. 2;

FIG. 4 is a schematic elevation view showing that the door lock assembly is in an unlocking position;

FIG. 5 is a sectional view taken along line 5-5 of FIG. 4;

FIG. 6 is a schematic elevation view showing that the door lock assembly is in a locking position; and

FIG. 7 is a sectional view taken along line 7-7 of FIG. 6.

### DETAILED DESCRIPTION OF THE PREFERRED EMBODIMENT

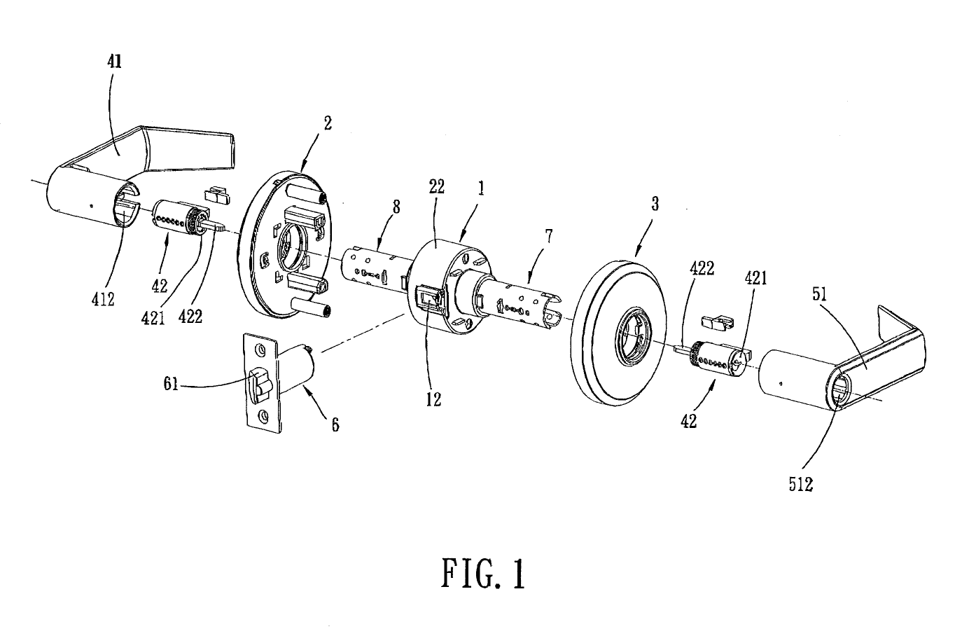

Referring to FIGS. 1 to 3, there is shown a door lock assembly embodying the present invention and including a latch-operating mechanism 1 mountable on a door through outer and inner rose assemblies 2 and 3, outer and inner handles 41, 51 connected respectively to the outer and inner rose assemblies 2 and 3, a latch unit 6 to latch or unlatch the door, and outer and inner transmission units 8 and 7 connected to the latch-operating mechanism 1.

Each of the outer and inner handles 41, 51 has a slot 412, 512, and a lock unit 42 mounted within the slot 412 or 512. The lock unit 42 has a key plug 421 and a tail piece 422.

The latch-operating mechanism 1 is known and includes a housing 22 carrying an operator case 11, a latch operator 12, and a bushing 21. The operator case 11 includes a base 111, and first and second cover plates 112, 113. The latch operator 12 is supported resiliently within the operator case 11.

The latch operator 12 includes an operator body 121 having an engaging part 122 to engage a latch 61 of the latch unit 6, a receiving part 123 opposite to the engaging part 122, a bearing part 124 disposed between the engaging part 122 and the receiving part 123, a retaining part 125 disposed within the receiving part 123 and having two retaining points 126, and two springs 127 having ends positioned to studs 114 and retaining points 126. Thus, the operator body 121 is biased by the springs 127 to move the latch 61 to a latching position.

Each of the outer and inner transmission units 8, 7 includes a sleeve 15, a spindle tube 13, a spindle drive 17, a ring member 19, a driven shaft 35 and a clutch tube 31.

The sleeve 15 of the outer or inner transmission unit 8, 7 has a notch 152, two protrusions 154, and an axial groove 153. The sleeves 15 are connected respectively to the outer and inner rose assemblies 2 and 3 in a known manner. The sleeves 15 are also connected respectively to the outer and inner handles 41, 51 in a known manner.

The spindle tube 13 is inserted rotatably into the sleeve 15, and has two opposite circumferential slots 131 each adjoining an axial slot 133, a spindle tab 132 to engage the bearing part 124 of the operator body 121, and two diametrically opposite limiting elements 135 projecting inwardly from an inner surface of the spindle tube 13 and disposed proximate to the spindle tab 132.

A retainer disc 36 is disposed transversely in the spindle tube 13 and has two opposite lugs 361 extending into the respective circumferential slots 131 in the spindle tube 13.

The driven shaft 35 is a stepped shaft inserted into the spindle tube 13 and including interconnected first, second, third and fourth sections 351, 352, 353 and 354. The first section 351 has an axial bore 359. The second section 352 has a transverse through hole 358 extending transversely through the second section 352. The third section 353 has an opposed pair of first engaging faces or first recessed faces 356, and an opposed pair of second engaging faces or second recessed faces 357. The first and second engaging faces 356, 357 are formed in an outer periphery of the third section 353 of the driven shaft 35 and are spaced apart from each other axially and angularly by a predetermined angle, particularly, by 90 degrees. The fourth section 354 is an enlarged end section of the driven shaft 35, and has a cavity 350 formed therein and opening at one end of the fourth section 354. A driven part 355 projects axially from the end of the fourth section 354.

The spindle drive 17 is configured as an annular body 170 disposed transversely in the spindle tube 13 and adjacent to the cavity 350 and the driven part 355. The spindle drive 17 has a central slot 171 for insertion of the tail piece 422 of the lock unit 42, two opposite retaining tongues 173 projecting axially from the annular body 170, and a driving tooth 172 projecting radially from the annular body 170. The retaining tongues 173 are fitted rotatably in the cavity 350 of the driven shaft 35. The driving tooth 172 is aligned annularly with the driven part 355 of the driven shaft 35, and the driven part 355 is rotatable around the annular body 170. The driving tooth 172 drives the driven part 355 after rotated by the tail piece 422.

The clutch tube 31 is inserted into the spindle tube 13 and has an interior axial hole 315 extending through two opposite ends of the clutch tube 31 to receive the first, second and third sections, 351, 352 and 353 of the driven shaft 35. The fourth section (enlarged end section) 354 of the driven shaft 35 is exposed from the clutch tube 31. The clutch tube 31 further has two helical slots 311 that extend around the driven shaft 35, two diametrically opposite limiting-grooves 312, and an engaging-groove 313 (second engaging element) spaced apart angularly from the limiting-grooves 312. The limiting-grooves 312 and the engaging-groove 313 extend axially in an outer periphery of the clutch tube 31. The limiting-grooves 312 engage slidably the respective limiting elements 135 of the spindle tube 13.

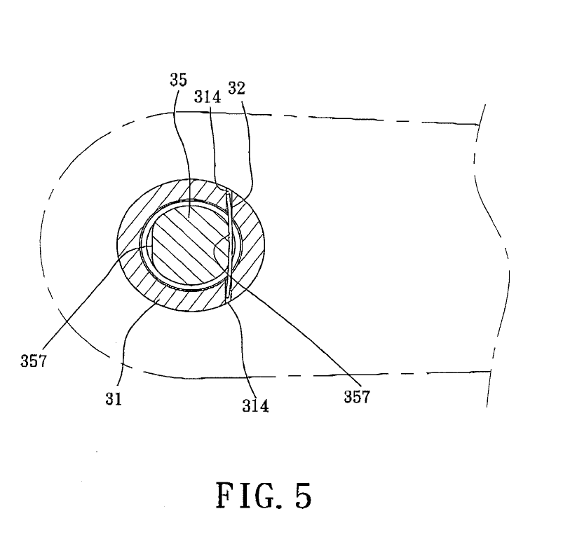

A pin 33 extends transversely through the through hole 358 of the driven shaft 35 and has two ends inserted respectively into the helical slots 311 of the clutch tube 31. A positioning spring 32, in the form of a spring plate, is disposed transversely in the clutch tube 31. Two ends of the positioning spring 32 are respectively inserted into two apertures 314 (FIG. 5) formed in the clutch tube 31. The positioning spring 32 contacts slidably the outer periphery of the third section 353 of the driven shaft 35 and moves between the first and second recessed faces 356 and 357 when the clutch tube 31 moves axially relative to the driven shaft 35.

The clutch tube 31 is therefore connected movably to the driven shaft 35, and can be moved by the driven shaft 35 to move the second engaging element or the engaging-groove 313 to a first engaging element 192 (which will be described hereinafter) when the door lock assembly is in an unlocking position, or away from the first engaging element 192 when the door lock assembly in a locking position. The positioning spring 32 engages resiliently the first recessed face 356 when the door lock assembly is in the locking position and engages resiliently the second recessed face 357 when the door lock assembly is in the unlocking position.

The first engaging element 192 is a finger piece connected to the sleeve 15. In this embodiment, the first engaging element or finger piece 192 is formed on a ring member 19 that is fixed around the sleeve 15. The ring member 19 has two indentations 193 interlocking with the respective protrusions 154 of the sleeve 15. The finger piece or first engaging element 192 projects from the ring member 19 and extends to the clutch tube 31. Preferably, the finger piece or first engaging element 192 projects radially from one end of the ring member 19 and extends releasably into the engaging-groove 313 of the clutch tube 31. The finger piece 192 passes through and engages the notch 152 of the sleeve 15.

Alternatively, the first engaging element or finger piece 192 may be directly connected to the sleeve 15 with the use of connecting elements, or by forming the finger piece 192 as one piece with the sleeve 15.

The bushing 21 has a central hole 211 to receive the sleeve 15 of the outer transmission unit 8, a substantially annular flange 212, two diametrically opposite notches 213 formed in the annular flange 212, and four slots 214 to engage hooks 115 provided in the base 111.

The housing 22 is substantially cylindrical, and has a constricted tubular portion 224 provided with a central bore 221, and four engagement slots 222. The operator case 11 is encased within the housing 22, and four of the hooks 115 of the base 111 engage the respective engagement slots 222. The sleeve 15 of the inner transmission unit 7 extends through the constricted tubular portion 224.

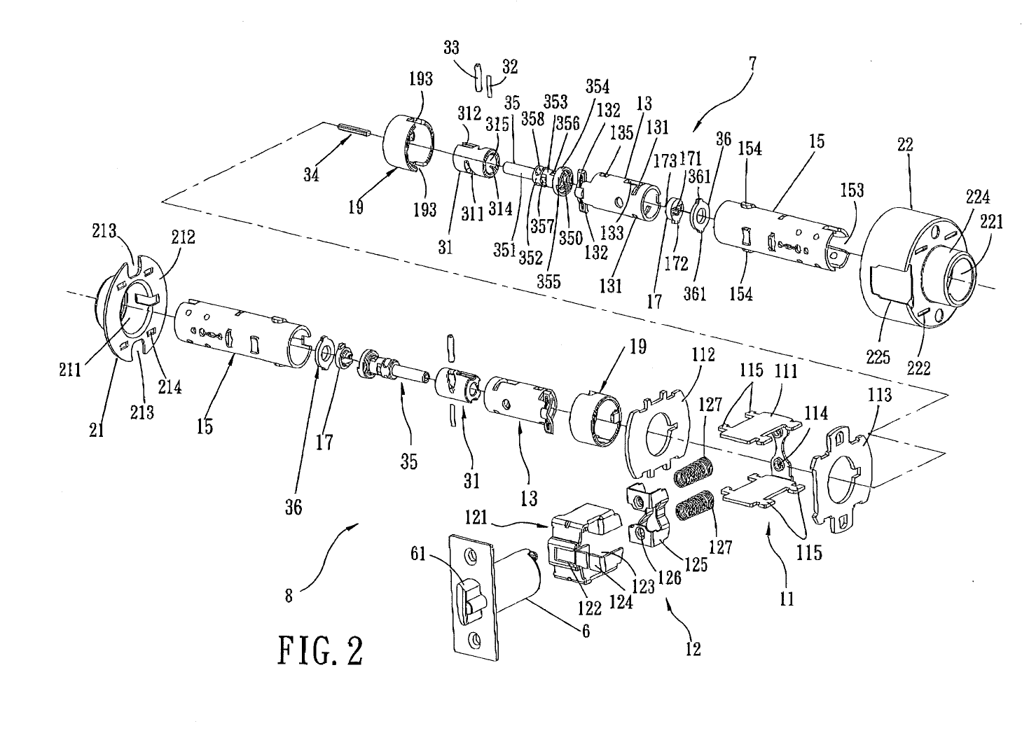

As described above, the outer and inner transmission units 8 and 7 are similar in construction and have the respective spindle tubes 13 connected to the latch operator 12. Thus, the operations of the outer and inner transmission units 8 and 7 are independent. However, if it is desired to interconnect the outer and inner transmission units 8 and 7, two ends of a rod 34 (FIG. 2) may be inserted respectively into the axial bores 359 of the driven shafts 35 of the outer and inner transmission units 8 and 7.

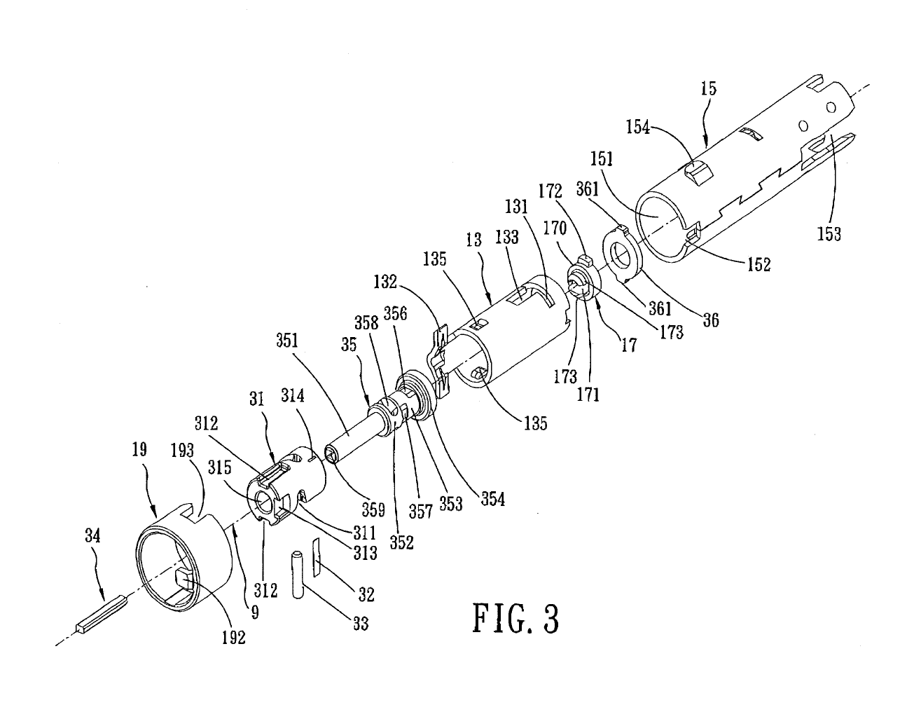

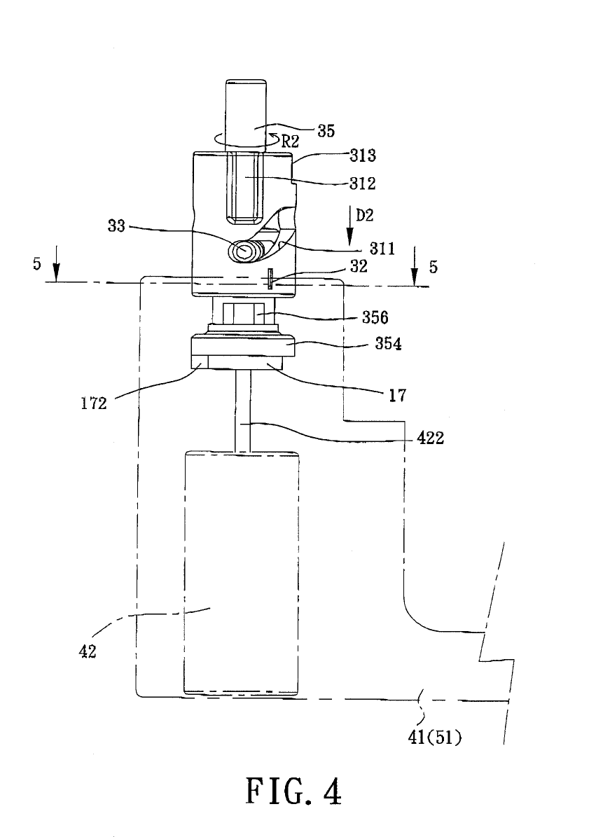

In use, the door lock assembly is mounted on a door and must be operated using a key either at the inside or the outside of the door. The operations of the door lock assembly at the inside and outside of the door are the same and are described hereinafter with reference to FIGS. 4-7 in combination with FIGS. 1 and 3.

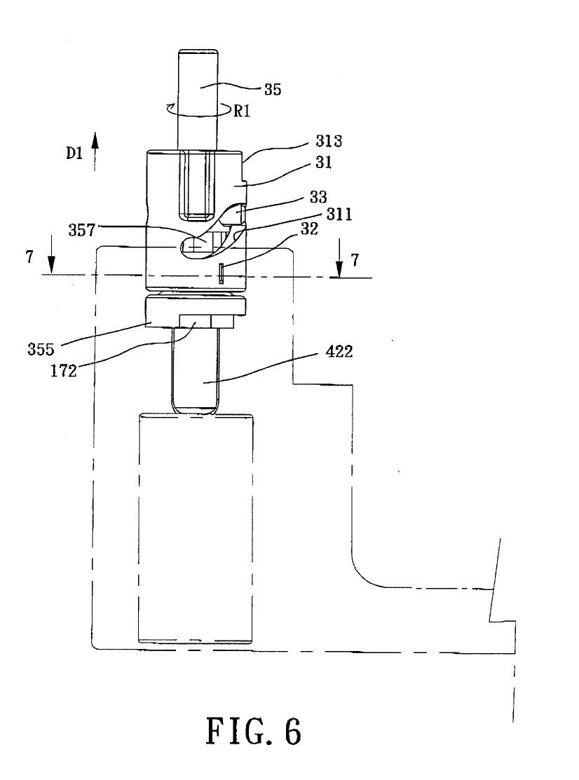

When the door lock assembly is to be placed in an unlocking position (FIGS. 4, 5) from a locking position (FIGS. 6,7), the lock unit 42 at the inside or outside of the door is operated using a key (not shown) to rotate the tail piece 422 so as to drive the spindle drive 17 and the driving tooth 172. The driving tooth 172 first rotates idly by a predetermined angle and then drives the driven part 355, thereby driving the driven shaft 35. Thus, the pin 33 of the driven shaft 35 rotates in a direction shown by an arrow (R1) in FIG. 6 and pushes one edge of each helical slot 311 of the clutch tube 31. As the clutch tube 31 is limited from rotation by virtue of the engagement of the limiting-grooves 312 of the clutch tube 31 and the limiting elements 135 of the spindle tube 13, the clutch tube 31 moves axially in a direction (D1) without rotation until the positioning spring 32 of the clutch tube 31 engages the second recessed face 357 as shown in FIGS. 4 and 5. As a result, the engaging-groove 313 of the clutch tube 31 moves toward the finger piece 192 of the ring member 19, thereby coupling the clutch tube 31 with the ring member 19 and the sleeve 15. At that time, when the handle 51 rotates the sleeve 15, the sleeve 15 in turn rotates the clutch tube 31 and the spindle tube 13, and the spindle tube 13 actuates the latch operator 12 to retract the latch 61, thereby permitting a door to open.

To remove the key from the lock unit 42, the key is rotated backward and pulled out from the lock unit 42. The tail piece 422 is therefore rotated backward so that the driving tooth 172 returns to its original position.

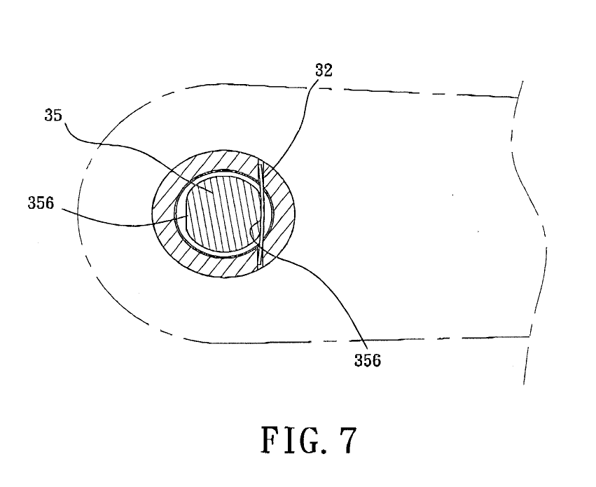

When the door lock assembly is to be placed in the locking position (FIGS. 6, 7) from the unlocking position (FIGS. 4, 5), the lock unit 42 is operated by turning the key in an opposite direction. The driving tooth 172 first rotates idly and then drives the driven part 355 and the driven shaft 35. Thus, the pin 33 of the drive shaft 35 rotates in a direction shown by an arrow (R2) in FIG. 4 and pushes another edge of each helical slot 311 of the clutch tube 31. As the clutch tube 31 is limited from rotation by virtue of the engagement of the limiting grooves 312 of the clutch tube 31 and the limiting elements 135 of the spindle tube 13, the clutch tube 31 moves axially in a direction (D2) without rotation until the positioning spring 32 of the clutch tube 31 engages the first recessed face 356, as shown in FIGS. 6 and 7. At this state, when the handle 41 or 51 is rotated, the handle 41 or 51 idles, and the door cannot be opened. When the key is rotated backward and removed, the driving tooth 172 returns to it original position.

While the clutch tube 31 is provided with two helical slots 311 to receive two ends of the pin 33 in the preferred embodiment, the present invention should not be limited thereto. The clutch tube 31 may be provided with one helical slot 311 to receive one end of the pin 33 so as to achieve the same effect.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

We claim:

1. A door lock assembly comprising:
a handle including a key plug that has a tail piece;
a sleeve connected to said handle and having a first engaging element connected to said sleeve;
a latch unit adapted to latch a door;
a spindle tube inserted rotatably into said sleeve and having a spindle tab to operate said latch unit;
a spindle drive disposed rotatably in said spindle tube, and having a driving tooth, and a central slot into which said tail piece is inserted;
a driven shaft disposed rotatably in said spindle tube, and having a driven part driven by said driving tooth to rotate said driven shaft; and
a clutch tube inserted movably into said spindle tube and sleeved movably around said driven shaft, said clutch tube having a second engaging element to engage releasably said first engaging element;
said clutch tube being connected movably to and moved by said driven shaft so that said second engaging element moves to and engages said first engaging element when the door lock assembly is in an unlocking position, or moves away from said first engaging element when the door lock assembly in a locking position.

2. The door lock assembly as claimed in claim 1, wherein said driven shaft further has a pin extending transversely through said driven shaft, said clutch tube further having a helical slot formed around said driven shaft, said pin extending into said helical slot.

3. The door lock assembly as claimed in claim 2, wherein said spindle tube further has a limiting element projecting from an inner surface of said spindle tube, said clutch tube further having a limiting-groove extending axially on an outer periphery of said clutch tube, said limiting element extending slidably into said limiting-groove.

4. The door lock assembly as claimed in claim 1, further comprising a ring member fixed around said sleeve, said first engaging element being a finger piece projecting from said ring member to said clutch tube, said second engaging element being an engaging-groove extending axially in an outer periphery of said clutch tube, said finger piece extending releasably into said engaging-groove.

5. The door lock assembly as claimed in claim 1, wherein said clutch tube further has a positioning spring disposed in said clutch tube, said driven shaft further having a first engaging face to engage releasably said positioning spring when the door lock assembly is in the locking position, and a second engaging face to engage releasably said positioning spring when the door lock assembly is in the unlocking position.

6. The door lock assembly as claimed in claim 5, wherein said first and second engaging faces are first and second recessed faces formed in an outer periphery of said driven shaft and spaced apart axially from each other, said positioning spring being disposed transversely in said clutch tube and contacting resiliently said outer periphery of said driven shaft.

7. The door lock assembly as claimed in claim 1, wherein said spindle drive has an annular body disposed adjacent said driven part, said driven part projecting axially from said driven shaft to move around said annular body, said driving tooth projecting radially from said annular body and being aligned annularly with said driven part.

8. The door lock assembly as claimed in claim 7, wherein said driven shaft further has a cavity adjacent to said annular body, said spindle drive further having retaining tongues projecting axially from said annular body and rotatably fitted in said cavity.

9. The door lock assembly as claimed in claim 8, wherein said driven shaft further has an enlarged end section that confines said cavity and that is exposed from said clutch tube.
